(19) United States
(12) Patent Application Publication
(10) Pub. No.: US 2006/0075002 A1
(43) Pub. Date: Apr. 6, 2006

(54) Method, system and software for journaling system objects

(75) Inventors: James Scott Tarbell, Wellington (NZ); David John Garvey, Tawa, Wellington (NZ)

Correspondence Address: NIXON & VANDERHYE, PC, 901 NORTH GLEBE ROAD, 11TH FLOOR, ARLINGTON, VA, 22203, US

(73) Assignee: MAXIMUM AVAILABILITY LIMITED, BROWNS BAY, AUCKLAND (NZ)

(21) Appl. No.: 10/531,260

(22) PCT Filed: Oct. 14, 2003
(86) PCT No.: PCT/NZ03/00228

§ 371 Date: Apr. 13, 2005

(30) Foreign Application Priority Data
Oct. 14, 2002 (NZ) 521983

(51) Int. Cl. G06F 17/30

(52) U.S. Cl. 707/204

(57) ABSTRACT

A method of journaling changes to system objects. A dummy function is substituted for a system function. The system function is executed under operation of the dummy function. Copies of system objects changed by execution of the system function are generated for journaling. Execution of the dummy function is then completed. Preferably the system objects are OS/400 system objects. The system objects may be program objects, configuration objects, queues and space/memory mapped objects. The copies of the system objects may be journaled for replication on another system. A system and software for journaling changes to system objects are also disclosed.

### FIELD OF INVENTION

The present invention relates to a method, system and software for journaling creation, change and deletion of system objects. More particularly, but not exclusively, the present invention relates to a method, system and software for journaling changes to general OS/400 system objects (including program objects, configuration objects, queues and space/memory mapped objects) in order to replicate these changes on the same or a remote system.

### BACKGROUND TO THE INVENTION

The IBM OS/400 operating system provides journaling of database changes via integrated system functions. This journaling function is primarily orientated toward recording database record level changes for system recovery, commitment control (e.g. to ensure transaction boundaries), auditing, and to support the replay of changes to a replica database (remote or local). Other system objects, such as programs and configuration objects, are not supported by the database journaling function. For these other system objects an independent System Audit Journal is maintained. The creation, deletion and changing of system objects may be recorded in the Audit Journal for the primary purpose of providing an audit of activity related to these objects. When viewed with the intention of providing replication of these objects to a remote or local (copy) the Audit Journal has several significant drawbacks, namely:
1. The Audit Journal entries are deposited and made available to other processes on the system only after the associated object activity has been performed. There is no way of trapping the object activity “as-it-happens”. This makes additional processing of the object by another system process difficult since the process, which is performing the object activity, is likely to lock and/or use the object before the related Audit Journal entry can be obtained by some monitoring process.
2. The Audit Journal entries are “system-wide”—there is one journal for all objects on the entire system. This requires any monitoring process to retrieve all of the journal entries even if only a small subset is required for replication.
3. The Audit Journal entries do not contain enough information to perform the associated object activity on another system (or local copy). This requires that any monitoring process must attempt to locate and lock the associated object in an attempt to make a copy prior to another change being performed on the object. If a copy can not be made of the exact state of the object, this state is “lost” and a replication process will be unable to provide the correct object state to a remote (or local copy) system.
4. The only way to serialise Audit Journal entries with a database journal is to attempt to use the journal entry timestamps to merge the Audit Journal entries with the associated database journal entries. This can cause significant overhead in processing the entries for replication. Additionally, when a system has multi-processors the timestamps contained in independent journals may not accurately reflect the exact sequence of operations.

Given these drawbacks, a foolproof method of synchronising system object changes with associated database changes using the Audit Journal has not been available. A method of capturing the content and state of system objects using the same database journal as is used to capture the actual database record level changes would ensure that the database and object changes could be replicated accurately to a remote (or local copy) system.

Since OS/400 system objects are created, changed, and deleted using a standard (finite) set of commands, the most obvious solution to obtaining state information (or making a copy of an object) is to provide replacement commands or to implement a command exit program. There are significant drawbacks to both of these approaches

The replacement system commands approach has the following drawbacks:
1. System command parameter interfaces to the associated OS/400 command processing programs can (and often do) change with each release of OS/400. This would cause significant dependency between the replication software and a given release of OS/400.
2. The number and complexity of the commands that would need to be replaced is high (over 150 commands, several with nested lists of parameters). Each command would need it's own replacement processing program as well as significant effort to ensure that each parameter is processed correctly (e.g. as it would be by the original OS/400 command).

The command exit point program approach has the following drawbacks:
1. Neither of the two registered exit points provided by OS/400 allow the associated exit program to be activated after the command has been executed. Therefore, in the case of object creation, change, deletion commands, the exit program is unable to process the resulting object.
2. The QIBM_QCA_CHG_COMMAND exit point is also limited as to the number of exit programs that can be registered. This could prevent some customers from using this exit point if other software uses the exit point.

It is an object of the present invention to provide a method, system and software for journaling system objects which overcomes the above drawbacks or to at least provide the public with a useful choice.

### SUMMARY OF THE INVENTION

According to a first aspect of the invention there is provided a method of journaling changes to system objects including the steps of:
i) substituting a dummy function for a system function;
ii) executing the system function under operation of the dummy function;
iii) generating copies of system objects, changed by execution of the system function, for journaling; and
iv) completing execution of the dummy function.

The dummy function may substitute the system function by having a duplicate calling name, and pre-empting the execution of the system function.

An exit point may be associated with the dummy function and an exit program may be registered for the exit point so that during operation of the dummy function the exit program may be executed.

The exit program may handle execution of the system function and capture changes to system objects occurring during such execution. Copies of the changes are generated by the exit program and may be saved to disk or streamed directly to a database system for journaling.

Alternatively, the exit program may be used to retrieve a command string for the system function and transmit this back to the dummy function. The dummy function may then handle execution of the system function and capture changes to system objects occurring during such execution. In such a case, copies of the changes are generated by the dummy function.

Preferably, the dummy function includes a replacement command and a replacement command processing program.

The database system may be incorporated with a replication system and may replicate the changes to other local or remote databases.

Messages or exceptions generated by the system function may be captured into a queue.

The dummy function may complete execution by forwarding any messages or exceptions generated by the system function back to the process which called the system function.

The system objects include program objects, configuration objects, queues and space/memory mapped objects.

Changes to system objects include creation, change, and deletion of system objects.

Preferably the system functions are those found on an OS/400 processor.

According to a further aspect of the invention there is provided a method of journaling changes to system objects including the steps of:
i) executing a system function during which changes to system objects occur; and
ii) journaling changes to system objects during execution of the system function.

One way that changes to system objects may be journaled during execution of the system function is by integrating journaling commands into the code of the system functions.

Another way that changes to system objects may be journaled during execution of the system function is by associating exit points with the system function so that during execution of the system function an exit program may be called to journal the system objects.

According to a further aspect of the invention there is provided a system for journaling changes to system objects including:
i) a processor adapted to execute a dummy function in place of a system function wherein the dummy function executes the system function and generates copies of system objects resulting from system function execution for journaling; and
ii) memory for use by the processor during execution.

Preferably the processor is an AS/400 processor.

According to a further aspect of the invention there is provided software for effecting the method of the first and second aspects of the invention.

### BRIEF DESCRIPTION OF THE DRAWING

The invention will now be described by way of example with reference to the accompanying drawing in which:

FIG. 1: shows an illustration of object journaling in relation to a OS/400 Class object.

FIG. 2: shows an illustration of an alternative embodiment of the invention.

### DETAILED DESCRIPTION OF PREFERRED EMBODIMENTS

The following description describes a system object journaling method operating under the OS/400 operating system. It will be appreciated that the method is applicable to other systems with appropriate modifications.

The method uses a combination approach to achieve the desired result; significantly reducing the drawbacks associated with any single approach.

A summary of the steps of the method follows:
i. An exact duplicate of each OS/400 command associated with object changes is made into a new library.
ii. The command processing program of each duplicate command is changed to a common supplier provided program which does not need to process any of the command parameters (and therefore is not affected by command parameter changes).
iii. A QIBM_QCA_RTV_COMMAND exit point program is registered for each (duplicate) command in the new library. This means that the exit program will be called before the associated Command Processing Program (e.g. the program specified in step ii).
iv. The new command library is placed in the system library search list, above the normal OS/400 system library (QSYS). This causes normal system users and application programs to invoke the commands from the new library rather than their counterparts in the OS/400 system library (QSYS).
v. The exit point program uses the passed command string, to execute the specified command using the original OS/400 command (in the OS/400 system library). The exit point program is then able to perform it's own processing (to capture the object changes) after the OS/400 command has been executed. Any messages sent by the OS/400 command to the exit point program are stored in a temporary queue so that they may be “resent” to the original requestor (e.g. the user and/or application program which submitted the command).
vi. The replacement (duplicate) Command Processing Program is then called by OS/400 (when the exit point program has completed). The common (replacement) Command Processing Program simply resends any messages contained in the temporary queue (placed there in step v).

In an alternative embodiment of the method steps v and vi may be replaced with:
v. The exit point program passes the command string, using a data queue, to the replacement (duplicate) Command Processing Program.
vi. The replacement (duplicate) Command Processing Program executes the specified command using the original OS/400 command (in the OS/400 system library). The (replacement) Command Processing Program, is then able to perform it's own processing (to capture the object changes) after the OS/400 command has been executed. Any messages sent by the OS/400 command to the (replacement) Command Processing Program are stored in a temporary queue and “resent” to the original requestor.

The method eliminates the need for a custom replacement command processing program for each duplicated command—a single, common program is used for each command. The use of the duplicate version of the commands to attach the exit point program, allows the exit point program (or the replacement Command Processing Program in the alternative embodiment) to control the processing of the actual system command—performing replication activities both before and after the associated object is created/changed/deleted.

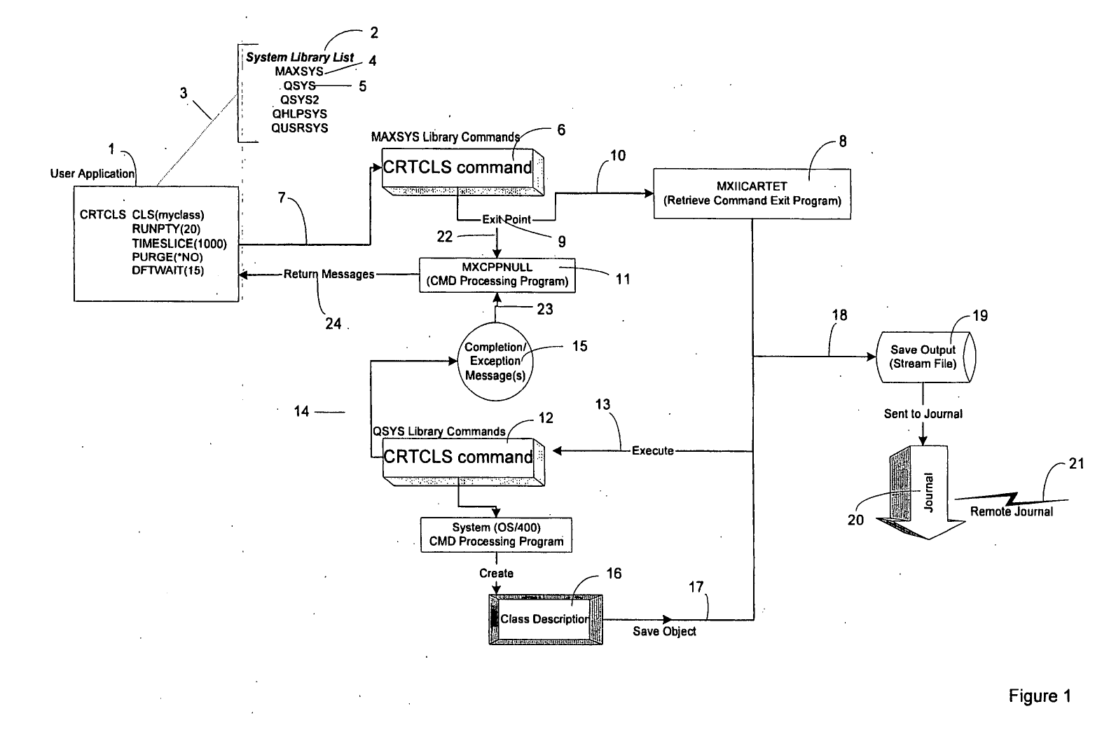

Referring to FIG. 1, the invention will be described in relation to journaling of a system object on a primary system for replication to a remote journal where the change to the system object is the creation of a OS/400 Class object by a user application and where an exit point program is used to control the processing of the actual system command.

The user application 1 runs with a system library search list 2 that places 3 the duplicate command library 4 (MAXSYS) above the operating system command library 5 (QSYS).

This causes the unqualified CRTCLS (Create Class Description) command 6 to bind 7 to the MAXSYS library version 4 of the command at run-time.

The replication program MXIICARTET 8 is registered as an exit program (using the system defined QIBM_QCA_RTV_COMMAND exit point 9) for the MAXSYS version of the CRTCLS command. This causes the MXIICARTET program 8 to be called 10 BEFORE the command's Command Processing Program 11 is called. The exit point interface passes the full command string text, as specified by the user application, to the exit program 8.

The exit program 8 performs any required pre-processing to determine if the associated object is defined for replication. The system version of the specified command 12 (in this case, the CRTCLS command) is executed 13 by the MXIICARTET program 8 and any messages generated 14 by the system command are stored in a temporary queue 15.

The affected object 16 (the new class description in this example) is saved 17 to a temporary save file by the MXIICARTET program.

The temporary save file is then copied 18 to a temporary OS/400 Integrated File System (IFS) stream file 19 which is journaled to the journal 20 used by the associated replication configuration (e.g. the same journal as used for the database files defined for replication). This effectively stores the save image into the journal.

The generated journal data is then transmitted 21 to the remote system(s) for replication using the standard OS/400 remote journal support.

The MXIICARTET program then returns control to its caller 9 (the system exit point), which then calls 22 the Command Processing Program (for the CRTCLS command in the MAXSYS library). For each command in the MAXSYS library, the Command Processing Program is MXCPPNULL 10.

The MXCPPNULL program 10 retrieves 23 the messages stored in the temporary 15 queue (by the MXIICARTET program), that were generated by the standard system version 12 of the command, and sends 24 them to the user application 1. This allows the user application 1 to process the messages exactly as if it had called the system version of the command directly.

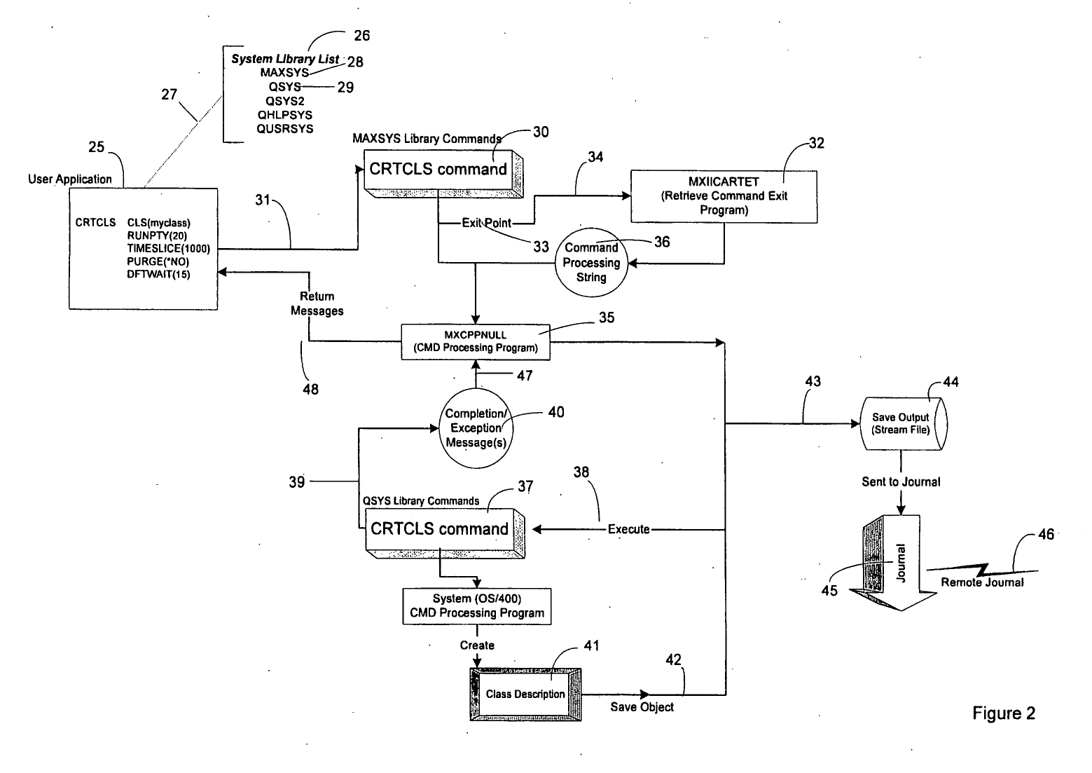

Referring to FIG. 2, the invention will be described in relation to journaling of a system object on a primary system for replication to a remote journal where the change to the system object is the creation of a OS/400 Class object by a user application and where a replacement Command Processing Program is used to control the processing of the actual system command.

The user application 25 runs with a system library search list 26 that places 27 the duplicate command library 28 (MAXSYS) above the operating system command library 29 (QSYS).

This causes the unqualified CRTCLS (Create Class Description) command 30 to bind 31 to the MAXSYS library version 28 of the command at run-time.

The replication program MXIICARTET 32 is registered as an exit program (using the system defined QIBM_QCA_RTV_COMMAND exit point 33) for the MAXSYS version of the CRTCLS command. This causes the MXIICARTET program 32 to be called 34 BEFORE the command's Command Processing Program 35 is called. The exit point interface passes the full command string text, as specified by the user application, to the exit program 32.

The exit program passes the full command string through a data queue 36 to the Command Processing Program (for the CRTCLS command in the MAXSYS library). For each command in the MAXSYS library, the Command Processing Program is MXCPPNULL 35.

The MXIICARTET program 32 then returns control to its caller 33 (the system exit point), and the MXCPPNULL 35 program is executed.

The MXCPPNULL 35 program performs any required pre-processing to determine if the associated object is defined for replication. The full command string is extracted from the data queue 36 and the system version of the specified command 37 (in this case, the CRTCLS command) is executed 38 by the MXCPPNULL program 35 and any messages generated 39 by the system command are stored in a temporary queue 40.

The affected object 41 (the new class description in this example) is saved 42 to a temporary save file by the MXCPPNULL program 35.

The temporary save file is then copied 43 to a temporary OS/400 Integrated File System (IFS) stream file 44 which is journaled to the journal 45 used by the associated replication configuration (e.g. the same journal as used for the database files defined for replication). This effectively stores the save image into the journal.

The generated journal data is then transmitted 46 to the remote system(s) for replication using the standard OS/400 remote journal support.

The MXCPPNULL program 35 retrieves 47 the messages stored in the temporary 40 queue, that were generated by the standard system version 37 of the command, and sends 48 them to the user application 25. This allows the user application 25 to process the messages exactly as if it had called the system version of the command directly.

Definitions

Class (Class Description) An object that identifies the run attributes of a job.
Command A statement used to request a function of the system. A command consists of the command name abbreviation, which identifies the requested function, and its parameters.
Command Processing A program that processes a command. This program Program (CPP) performs some validity checking and processes the command so that the requested function is performed.
Exit Program 1. A user-written program that is given control during operation of a system function.
2. A program to which control is passed from an exit point.
Save File A file allocated in auxiliary storage that can be used to store saved data on disk (without requiring diskettes or tapes).
System Audit Journal A journal used by the system to keep a record of security-relevant events that occur.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1-45. (canceled)

46. A method of journaling changes to system objects including the steps of:
i) substituting a dummy function for a system function;
ii) executing the system function under operation of the dummy function;
iii) generating copies of system objects, changed by execution of the system function, for journaling; and
iv) completing execution of the dummy function.

47. A method as claimed in claim 46 wherein the dummy function substitutes the system function by having a duplicate calling name and pre-empting the execution of the system function.

48. A method as claimed in claim 47 wherein an exit point is associated with the dummy function and an exit program registered for the exit point.

49. A method as claimed in claim 48 wherein during operation of the dummy function the exit program is executed.

50. A method as claimed in claim 49 wherein the execution of the system function is handled by the exit program.

51. A method as claimed in claim 50 wherein the system objects changed by execution of the system function are captured by the exit program.

52. A method as claimed in claim 51 wherein the exit program generates copies of the system objects captured by the exit program.

53. A method as claimed in claim 49 wherein the execution of the system function is handled by the dummy function.

54. A method as claimed in claim 53 wherein the system objects changed by execution of the system function are captured by the dummy function.

55. A method as claimed in claim 54 wherein the exit program generates copies of the system objects captured by the dummy function.

56. A method as claimed in claim 52 wherein the copies of the system objects are saved to disk.

57. A method as claimed in claim 52 wherein the copies of the system objects are streamed to a database system for journaling.

58. A method as claimed in claim 57 wherein the database system is incorporated with a replication system.

59. A method as claimed in claim 58 wherein the replication system replicates the copies of the system objects to one or more local or remote databases.

60. A method as claimed in claim 52 wherein messages or exceptions generated by the system function are captured into a queue.

61. A method as claimed in claim 60 wherein the system function is originally called by a process and the messages or exceptions are forwarded back to the process by the dummy function.

62. A method as claimed in claim 52 wherein the system objects are one or more of the set of program objects, configuration objects, queues, and space/memory mapped objects.

63. A method as claimed in claim 52 wherein the changed system objects are those system objects which have been created, changed or deleted.

64. A method as claimed in claim 52 wherein the system functions are OS/400 system functions.

65. A method of journaling changes to system objects including the steps of:
v) executing a system function during which changes to system objects occur; and
vi) journaling changes to system objects during execution of the system function.

66. A method as claimed in claim 65 wherein changes to system objects are journaled by integrating journaling commands into the code of the system functions.

67. A method as claimed in claim 65 wherein changes to system objects are journaled by associating exit points with the system function and calling an exit program during execution of the system function.

68. A system for journaling changes to system objects including:
vii) a processor adapted to execute a dummy function in place of a system function wherein the dummy function executes the system function and generates copies of system objects resulting from system function execution for journaling; and
viii) memory for use by the processor during execution.

69. A system as claimed in claim 68 wherein the dummy function substitutes the system function by having a duplicate calling name and pre-empting the execution of the system function.

70. A system as claimed in claim 69 wherein an exit point is associated with the dummy function and an exit program registered for the exit point.

71. A system as claimed in claim 70 wherein during execution of the dummy function the exit program is executed.

72. A system as claimed in claim 71 wherein the execution of the system function is handled by the exit program.

73. A system as claimed in claim 72 wherein the system objects changed by execution of the system function are captured by the exit program.

74. A system as claimed in claim 72 wherein the exit program generates copies of the system objects captured by the exit program.

75. A system as claimed in claim 71 wherein the execution of the system function is handled by the dummy function.

76. A system as claimed in claim 75 wherein the system objects changed by execution of the system function are captured by the dummy function.

77. A system as claimed in claim 76 wherein the exit program generates copies of the system objects captured by the dummy function.

78. A system as claimed in claim 74 wherein the copies of the system objects are saved to disk.

79. A system as claimed in claim 74 wherein the copies of the system objects are streamed to a database system for journaling.

80. A system as claimed in claim 79 wherein the database system is incorporated with a replication system.

81. A system as claimed in claim 80 wherein the replication system replicates the copies of the system objects to one or more local or remote databases.

82. A system as claimed in claim 74 wherein messages or exceptions generated by the system function are captured into a queue.

83. A system as claimed in claim 82 wherein the system function is originally called by a process and the messages or exceptions are forwarded back to the process by the dummy function.

84. A system as claimed in claim 74 wherein the system objects are one or more of the set of program objects, configuration objects, queues, and space/memory mapped objects.

85. A system as claimed in claim 74 wherein the changed system objects are those system objects which have been created, changed or deleted.

86. A system as claimed in claim 74 wherein the processor is an AS/400 processor.

87. A system as claimed in claim 86 wherein the processor is operating under the OS/400 operating system.

88. A computer system for effecting the method of claim 46.

89. A computer system for effecting the method of claim 65.

90. Software for effecting the method of claim 46.

91. Software for effecting the method of claim 65.

92. Storage media containing software as claimed in claim 90.

93. Storage media containing software as claimed in claim 91.
